(19) United States
(12) Patent Application Publication
(10) Pub. No.: US 2016/0065479 A1
(43) Pub. Date: Mar. 3, 2016

(54) DISTRIBUTED INPUT/OUTPUT ARCHITECTURE FOR NETWORK FUNCTIONS VIRTUALIZATION

(71) Applicant: rift.IO, Inc., Burlington, MA (US)

(72) Inventors: Matthew Hayden HARPER, Salem, NH (US); Timothy Glenn Mortsolf, Amherst, MA (US)

(21) Appl. No.: 14/836,513

(22) Filed: Aug. 26, 2015

Related U.S. Application Data
(60) Provisional application No. 62/042,049, filed on Aug. 26, 2014.
(60) Provisional application No. 62/042,436, filed on Aug. 27, 2014.

(51) Int. Cl. H04L 12/803; H04L 12/851; H04L 12/819

(52) U.S. Cl. CPC H04L 47/125; H04L 47/21; H04L 47/2441

(57) ABSTRACT

System, method, and computer product embodiments for providing a distributed input/output (I/O) architecture for network functions virtualization. A first load balancer includes an I/O interface for receiving a packet from a network. The first load balancer constructs a flow key using portions of the packet. The flow key is hashed to generate a bucket value. Then, the first load balancer locates a second load balancer for processing the packet by looking up the bucket value from a lookup table stored on the first load balancer. Finally, the first load balancer forwards at least one of the packet, the flow key, or metadata associated with the packet to the second load balancer causing the second load balancer to perform a flow key lookup to determine an application server for processing the packet.

### CROSS REFERENCE TO RELATED APPLICATIONS

This application claims the benefit of U.S. Provisional Patent Application No. 62/042,049, filed Aug. 26, 2014, titled “DISTRIBUTED INPUT/OUTPUT ARCHITECTURE FOR NETWORK FUNCTIONS VIRTUALIZATION,” and U.S. Provisional Patent Application No. 62/042,436 (Atty. Docket No. 3561.0070000), filed Aug. 27, 2014, titled “CLOUD PLATFORM FOR NETWORK FUNCTIONS,” both of which are hereby incorporated herein by reference in their entirety.

### BACKGROUND

Traditionally, complex Internet Protocol (IP) network functions architecture (including components such as routers, firewalls, load balancers, and subscriber management systems) are designed and constructed using purpose-built proprietary networking hardware (e.g. NPUs, ASICs, TCAMs, FPGAs) in combination with appropriate specialized packet processing software. The purpose-built solutions that make up the core of today's high-speed communication networks are extremely reliable, highly-optimized, and generally have the ability to handle traffic at wire-speed on the highest-speed I/O interfaces that are commercially available.

These proprietary and purpose-built solutions, however, are very expensive and do not scale well beyond a single physical hardware unit. Additionally, traditional purpose-built hardware for network functions are designed to gracefully handle hardware and software faults. Such systems purporting to be “carrier-class” typically advertise 99.999% (i.e. 5-9 s) availability. It is very complex (and expensive) to build networking equipment that is reliable and internally fully redundant. An internally fully redundant system requires everything from power supplies to memories to and to the communication fabric to have backup hardware instances.

On the other hand, much of today's web networking infrastructure is built using all-software solutions, this is commonly referred to as “the cloud.” The cloud allows for massive scalability using inexpensive non-proprietary hardware. But, while the cloud model has allowed the massive scaling of applications, scalability has been hampered by the physical hardware's limited input/output (I/O) capabilities.

Commonly, the servers deployed in cloud environments are built only to be semi-reliable (well below 5-9's availability) and they are interconnected using a non-redundant IP switching architecture. These systems make up for limited hardware reliability by being inexpensive and easily scalable. Thus, what is needed is a system that has the flexibility of cloud-based solutions but the reliability of hardware-based solutions for network functions.

### BRIEF DESCRIPTION OF THE DRAWINGS

The accompanying drawings are incorporated herein and form a part of the specification.

FIGS. 1A-B are block diagrams illustrating a distributed I/O architecture system suitable for Network Functions Virtualization (NFV) in a cloud environment, according to example embodiments.

FIG. 2 is an example block diagram illustrating the components in a processing node implementing load balancing in the distributed I/O architecture system, according to an example embodiment.

FIG. 3 is a flowchart illustrating a process for load balancing in the distributed I/O architecture system, according to an example embodiment.

FIG. 4 is a flowchart illustrating a process for performing load balancing in the distributed I/O architecture system when flows are remapped, according to an example embodiment.

FIG. 5 is a flowchart illustrating steps for detecting and responding to changes in the distributed I/O architecture system, according to an example embodiment.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for utilizing a distributed input/output (I/O) architecture to implement Network Functions Virtualization (NFV) with software redundancy, hardware redundancy, and throughput scalability. For example, embodiments may programmatically distribute inbound (and collect outbound) packet traffic to multiple distributed application servers acting as a single entity. This ability may be highly desirable because offering a reliable service on a single address (or pool of addresses) that transparently scales from a few gigabits/sec to terabits/sec may drastically simplify service creation, rollout, and scaling. In an embodiment, commercial off-the-shelf (COTS) I/O servers or virtual machines (VM) running on COTS servers may be dynamically programmed to match packet traffic flows and to load balance inbound packet traffic to one of many COTS application servers. This scheme may allow multiple COTS servers talking over multiple low-speed links to appear as a single entity, i.e. as a single Internet Protocol (IP) address, to the external IP network.

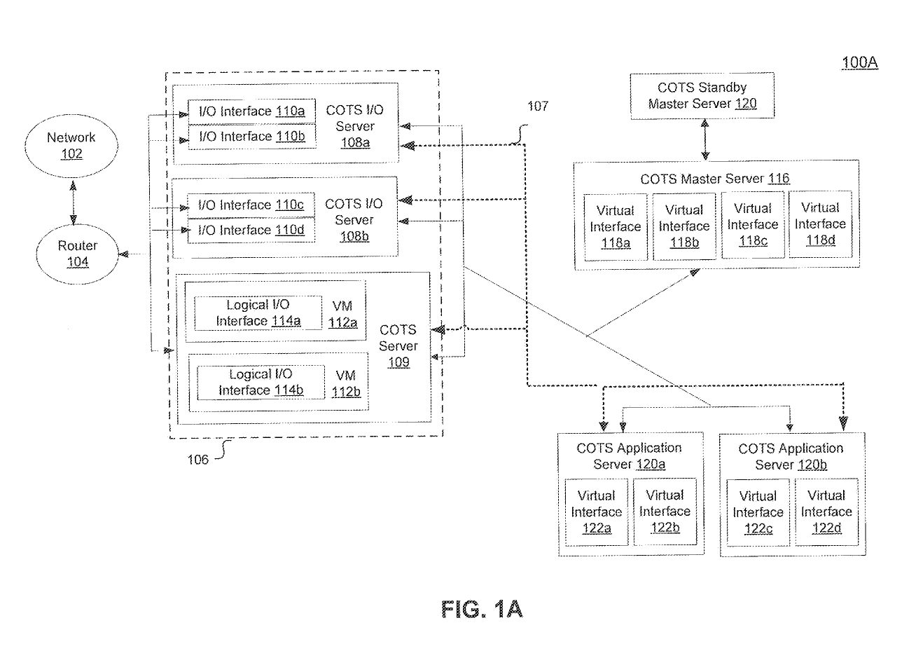

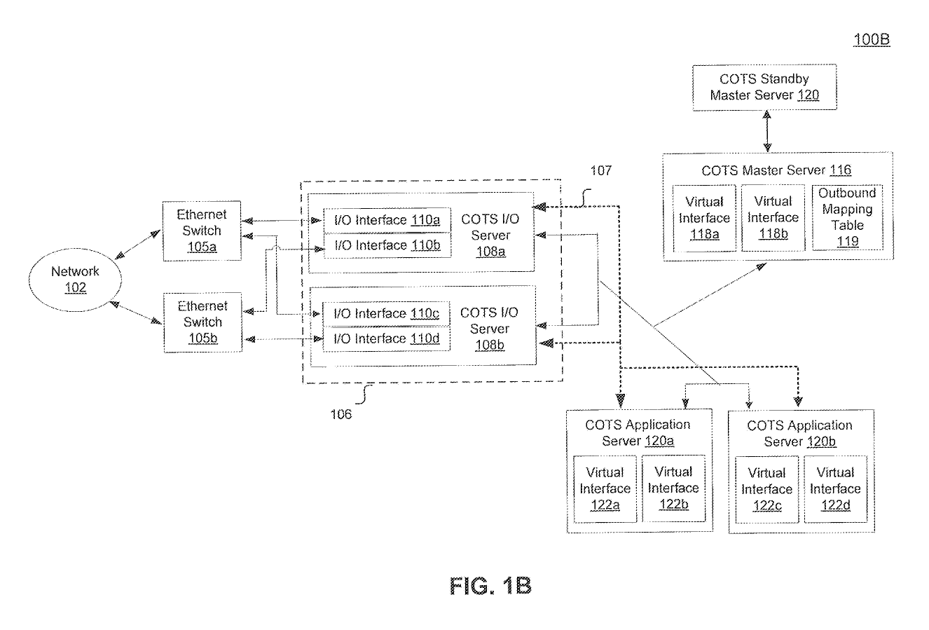

FIG. 1A illustrates a distributed I/O architecture system for implementing Network Functions Virtualization (NFV) in a cloud environment, according to an embodiment. Distributed I/O system 100A includes network 102, router 104, virtual fabric 107, I/O interfaces 110, logical I/O interfaces 114, COTS I/O servers 108, COTS server 109, Virtual Machines (VMs) 112, COTS standby master server 120, COTS master server 116, COTS application server 120, and virtual interfaces 118 and 122. Although distributed I/O system 100A depicts these components separately, one of ordinary skill in the art would understand that distributed I/O system 100A may have more or less of any of the labeled components in different arrangements, according to the intended purpose.

One method of creating a scalable and redundant I/O system over the cloud is to create a virtual system where I/O interfaces are spread across and communicate among multiple processing entities. These cooperating processing entities may include BMs, COTS servers, and/or blade server systems as typically found in datacenters and cloud-type environments. In distributed I/O system 100A, physical I/O interfaces 110 are spread across COTS I/O servers 108 and logical I/O interfaces 114 are spread across VMs 112 implemented on one or more COTS server 109.

Router 104 is a networking device that receives data packets from network 102, which may include any type of network, for example, a wide area network (WAN) such as the Internet. Router 104 may forward those data packets to one of the I/O interfaces 110 or logical I/O interfaces 114. In an embodiment, inverse multiplexing techniques may be used to achieve bandwidths greater than that of a single physical or logical I/O interface towards the network 102 i.e. external IP network. The following methods may be used to support inverse multiplexing on the I/O interfaces: Link Bonding, Link Aggregation (LAG—802.3ad), and equal cost multi-path (ECMP). By using these methods on router 104, in the case of an external switch or cable failure, the LAG, bonding, or ECMP may enable router 104 to automatically detect the failure(s) and use the remaining links that are currently available.

In an embodiment, router 104 contains a separate router interface that determines whether a packet P1 from network 102 needs to be directed to a particular Link Aggregation Group (LAG) group 106. Then, router 104 may forward that packet P1 into an I/O interface 110 of LAG group 106. Alternatively, router 104 may forward packet P1 into the I/O interface on another processing entity, such as logical I/O interface 114a on VM 112a. Link aggregation such as LAG, sometimes known as interface bonding, joins the physical I/O interfaces 110 of the COTS I/O servers 108 and logical I/O interfaces 114 of Virtual Machines (VM) 112 into a single virtual interface, represented by LAG group 106. LAG group 106 may comprise various types of I/O interfaces 110 across COTS I/O servers 108. This virtual interfaced LAG group 106 may be configured to allow for high availability, increased software and hardware redundancy, and increased throughput scalability.

In one embodiment, router 104 may be capable of parsing and processing the packet P1 in order to direct the packet P1 to, for example, I/O interface 110a of LAG group 106. Router 104 may be configured with hashing algorithms defined by the Internet Engineering Task Force (IETF). Upon configuration, router 104 may hash an IP address, User Datagram Protocol (UDP) port number, Transmission Control Protocol (TCP) port number, or other control information of the packet P1 into a particular bucket defined by the hashing algorithm. This hashing and bucket scheme ultimately routes the packet P1 to, for example, I/O interface 110a. Thus, in an embodiment, router 104, effectively, performs a preliminary load balancing procedure by distributing packets across multiple I/O interfaces 110 and logical I/O interfaces 114, if any, of LAG group 106.

FIG. 1B, illustrates I/O architecture system 100B that is similar to distributed I/O system 100A. Instead of router 104 directing packets from the network 102 into I/O interfaces 110 (or logical I/O interfaces 114), at least two separate Ethernet switches 105 may be used. By cabling I/O interfaces to redundant switches using methods like Multi-Chassis LAG (MC-LAG), each I/O interface on a COTS server 108 or VM 110 may be protected against an external switch failure. For example, Ethernet switch 105a may still service I/O interfaces 110 on both COTS I/O Servers 108a and 108b even if Ethernet switch 105b fails. In an embodiment, Cisco Virtual Port Channels (VPC) may be used instead because this method may allow physically distinct switches to act as one large switch.

COTS I/O servers 108 may each contain multiple I/O interfaces 110. A COTS I/O server 108 may be a processing entity (e.g. a COTS server) that has been designated as an I/O server. Other processing entities, such as VMs 112 have also been designated as I/O servers in distributed I/O system 100A. These I/O servers may also serve as load balancing nodes in distributed I/O system 100A and 100B and contain processes and code for load balancing inbound and outbound packet traffic.

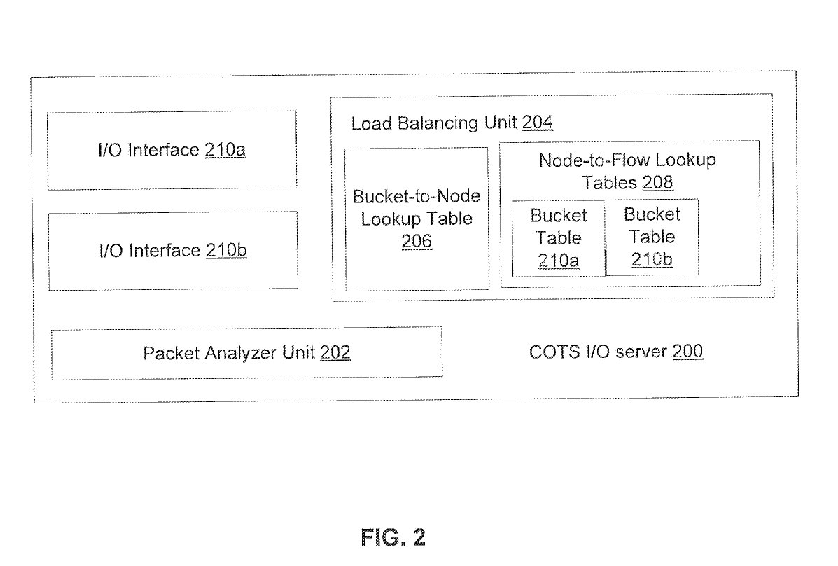

FIG. 2 illustrates COTS I/O server 200 configured as a load balancing node, according to an exemplary embodiment. For example, COTS I/O server 108a may be configured as COTS I/O server 200. In an embodiment, the I/O processes and the load balancing processes are performed by separate processing entities (COTS server, VMs, blade servers, etc.). In an embodiment, COTS I/O server 200 may receive a packet P1 from router 104 through I/O interface 210a. For example, I/O interfaces 210 may be the same I/O interfaces 110 of FIG. 1.

In an embodiment, COTS I/O server 200 may first perform basic standard I/O interface operations, such as Quality of Service (QOS), on an input interface. For example, COTS I/O server 200 may determine whether rate limiting is required. COTS I/O server 200 may then perform validation operations such as discarding the packet P1 due to a firewall Access Control List rule specifying packets with a LDP port number that are the same as the port number of packet P1 should be blocked. Various procedures and rules may be dynamically programmed into the load balancing nodes, for example VM 112b or COTS I/O server 108a, by a COTS master server 116.

In an embodiment, load balancing unit 204 in COTS I/O server 200 may first construct a flow key representing the type of application the received packet is directed towards based, at least in part, on the particular protocol associated with the key. In an embodiment, IP addresses and port IDs of the packet may be concatenated to form, at least, a portion of the flow key. For example, if packet P1 is identified as an HTTP packet, COTS I/O server 200 may concatenate the IP address and the port number of packet P1 in order to construct the flow key. As another example, if packet P1 is identified as an HTTP proxy packet, load balancing unit 204 may construct the flow key for packet P1 using the IP address, port number, and the uniform resource identifier of packet P1.

For a packet P1 identified as a Session Initiation Protocol (SIP) packet, which is used in controlling multimedia communication sessions such as voice and video calls over Internet Protocol (IP) networks, load balancing unit 204 may inspect SIP packet to retrieve session ID per SIP and deliver to a specific application server. For transferring media streams, SIP may typically employ the Real-time Transport Protocol. In this particular case, load balancing unit 204 may detect a key for the SIP and a separate key for the RTP. Load balancing unit 204 may maintain the two separate, potentially different, flow keys. But, both keys may ultimately point to the same process on the same VM or COTS server for the particular session.

In another example, if packet P1 is identified as a GPRS Tunneling Protocol (GTP) packet, load balancing unit 204 may use the GTP tunnel endpoint identifier, which is an equivalent session ID for a SIP protocol, plus the endpoint IP address to construct the packet P1 flow key. Persons skilled in the art(s) may construct a flow key from a packet using any of a numerous number of protocols. Particularly, load balancing unit 204 can process Diameter protocol packet, which typically uses Transmission Control Protocol (TCP) or Stream Control Transmission Protocol (SCTP) as its transport protocol, which may be considered as a layer 7 operation. Proxy packets to different Diameter endpoints may be utilized in constructing the flow keys to deal with Diameter payloads. The rules for constructing and extracting a flow key for a data packet like packet P1 are programmable and stored on the load balancing nodes, such as COTS I/O server 200.

Load balancing unit 204 on COTS I/O server 200 may hash the constructed flow key into a particular bucket of keys from the numerous buckets of keys in LAG group 106, thereby generating a bucket value. Typically, there may be many more buckets than the number of servers to allow for a better load distribution. For example, consider a LAG group that contains 100 load balancing nodes or COTS I/O servers and 64,000 total buckets. Each load balancing node of the LAG group may be assigned 640 of those buckets, if the buckets are evenly distributed across the nodes. In one embodiment, each bucket is uniquely owned by one server or node in the LAG group. In an embodiment, the contents of each bucket may physically reside on one or more servers in the LAG group. This increases redundancy in the system and may increase performance by processing multiple flow keys hashed into the same bucket at different nodes simultaneously. So in the previous example, a server of the 100 servers in the LAG group may own more than 640 of the 64,000 buckets. COTS I/O server 200 may then look up in bucket-to-node lookup table 206, for the particular hashed bucket value, which particular COTS I/O server 108 or node owns the particular bucket then forward the packet to the looked up COTS I/O server 108 or node. Additionally, COTS I/O server 200 may transmit metadata associated with the packet or associated with the extracted/constructed flow key to the second processing node (i.e. the looked up COTS I/O server 108). The metadata may specify the flow key and possibly the specific process on a specific application of COTS application servers 102 capable of processing or executing packet P1.

In an embodiment, the looked-up COTS I/O server 108 may be COTS I/O server 200 itself. In an embodiment, the looked-up COTS I/O server 108 may be any processing entity like COTS I/O server 108b or VM 112a on COTS server 109. In some embodiments, processing entities including VMs 112 and COTS I/O servers 108 contain the same components as depicted in FIG. 2.

In an embodiment, assuming the looked-up node is VM 112a on COTS server 109, upon receiving the packet from COTS I/O server 108a, VM 112a may re-extract and construct the flow key through a component analogous to load balancing unit 204. In an embodiment, VM 112a may operate more efficiently by using the tunneled metadata, sent by COTS I/O server 108a, instead of reproducing the flow key. VM 112a effectively acts as a second load balancing node because VM 112a may too look up the flow key in tables analogous to node-to-flow lookup tables 208. In an embodiment, bucket 1 may correspond to bucket table 210a. If packet P1 hashed to bucket 1, then bucket table 210a may be used to look up the entry associated with the flow key. Bucket table 210a stores a subset of the possible flows of bucket 1 in the physical memory of the second load balancing node. The same subset or a portion of the subset of possible flows may be redundantly stored in other COTS I/O servers 108 to improve redundancy and processing availability.

Upon successfully looking up the entry in the table (such as bucket table 210a) corresponding to the flow, I/O COTS server 200 uses the entry to identify one of COTS application servers 120 or the process on the identified COTS application server to processes the flow. In an embodiment, the second load balancer, VM 112a, may tunnel the packet P1 as well as additional associated metadata to COTS application server 120a. The metadata comprises a virtual process identifier, which may indicate a process ID corresponding to a process on COTS application server 120a that may be needed to process the packet P1. In an embodiment, the metadata may comprise the process ID itself. In an embodiment, the second load balancing node may not recognize the flow and additional previously programmed rules and procedures downloaded to the second load balancing node by the COTS master server 120 may resolve the missing flow.

In an embodiment, flows may be permitted to relocate from one load balancer to another load balancer while the packet P1 is in transit from one load balancing node to another. For example, the flow located in bucket table 210a may have been relocated from the second load balancing node to another node while the packet P1 is being transmitted. This situation may occur if the COTS master server 11 is trying to rebalance the distribution of flows across the load balancers or handle redundancy events. In such a case, the second load balancing node may fail to look up the flow key in its node-to-flow lookup tables 208 because the flow has moved (i.e. bucket tables 210 have been updated) and cannot be found in any bucket tables 210 of node-to-flow lookup tables 208. The second load balancing node may subsequently relocate the correct bucket using the bucket-to-node lookup table 206 and an associated third load balancing COTS I/O server 108 or VM 112. Then, the second load balancer may forward the packet, flow key, and associated metadata to the third load balancer node. In an embodiment, the second load balancing node may not need to recalculate the bucket hash using the flow key.

In order to process packets that are involved in IP fragmentation and IP reassembly, COTS I/O servers 108 may require fully reassembled protocol data units (PDUs) in order to match traffic flows and load balance inbound traffic to one of COTS application servers 120 (i.e. for inbound traffic bypassing the master COTS server 116). In an embodiment, for all traffic requiring classification beyond layer 3, distributed I/O system 100A performs distributed IP reassembly across multiple COTS I/O servers 108. Distributed I/O system 100A may accomplish this by having COTS I/O servers 108 receiving a fragment of the PDU to compute a hash using the following information from the protocol data unit (PDU): PDU source-address, PDU destination-address, protocol type, and IP ID, COTS I/O servers 108 receiving the PDU fragment may then map the constructed flow key with an associated bucket value via a lookup table like bucket-to-node lookup table 206 to one of the load balancing COTS I/O servers. As a result, COTS I/O servers 108 may send fragments relating to a particular PDU to the same load balancing COTS I/O server for reassembly regardless of the I/O interface 110 (or logical I/O interface 114) on which the packet fragment originally arrived.

By performing reassembly in a distributed fashion. COTS master server 116 may avoid being overloaded. One possible heuristic optimization may have each inbound interface, such as I/O interface 110 or logical I/O interface 114, perform a localized form of IP reassembly for a short period of time for PDU fragments received across the I/O interfaces before sending the reassembled PDU fragments at each inbound interface to the looked up COTS I/O server 108, acting as a load balancing node, determined by the hash lookup. This approach may be useful when the remote system sends all of the fragments for a PDU down the same Ethernet link.

Outbound packets may similarly need to be fragmented. Specifically, the outbound packets may require fragmentation either within distributed I/O system 100A itself or somewhere along the path to its final destination. In an embodiment where multiple COTS application servers 120 may share the same interface address, the multiple COTS application servers 120 may potentially generate a packet requiring fragmentation that had the same IP source address, destination address, and IP ID. In such an embodiment, the destination entity such as another distributed I/O system 100 (which may need to perform IP reassembly) may be unable to correctly reassemble the packet. To prevent this situation, distributed I/O system 100A may assign each outbound PDU fragment a new IP ID when the packet's source address corresponds to one of its virtual interface addresses. This reassignment occurs on COTS I/O server 108. Each COTS I/O server 108 may be assigned a range of unique IP IDs to prevent overlapping IDs across COTS I/O servers 108.

COTS I/O server 200, such as load balancing COTS I/O server 108a, may also contain or be coupled to packet analyzer unit 202. Packet analyzer unit 202 may selectively forward information and data states in COTS I/O server 200 to a packet analyzer tool, such as WIRESHARK, running on a COTS application server or separate server not shown in FIGS. 1A-B. For example, packet analyzer unit 202 may filter for all flows of a user-specified type, a key with a value specified by a user, a particular packet type contained in a bucket specified by the user, or a particular bucket. Packet analyzer unit 202 may be particularly useful for a user or cloud network administrator for debugging any potential errors or faults in distributed I/O system 100A. The metadata generated previously may also be forwarded to a packet analyzer tool like WIRESHARK, where a custom software decoder coupled to WIRESHARK may allow a user to observe internal information states of distributed I/O system 100A, such as hash values in a bucket-to-node lookup or the number of buckets assigned by the COTS master server 116, etc. In an embodiment, packet information and data describing the state of the system at a particular time (identified for example by a timestamp) may be copied/forwarded to a separate debugging logging subsystem or from COTS I/O server 200 to a corresponding virtual interface 118 in COTS master server 116. This debugging logging subsystem may store various packet and system state information spanning a certain time interval and perform additional finer or more complex filtering requested by a user, before transmitting the requested data to WIRESHARK to be displayed to the user.

In an embodiment, when COTS application server 120a receives packet P1, COTS application server 120a may initiate an inspection of the virtual identifier (ID) in the metadata to retrieve and extract the process number identifier. In an embodiment, COTS application server 120a looks up the virtual process identifier in a table to retrieve the process number. Then, COTS application server 120a may deliver the packet to that process. Mapping a virtual process ID to a real process allows for a flow to be easily moved from one process to another without needing to update the properties of the flow in the COTS master server 116, COTS I/O servers 108, and/or VMs 112. The virtual process ID table, contained in virtual interfaces 122 on the COTS application servers 120 may be updated instead to reflect the change in ownership of that flow. The virtual interfaces 122 contained in the COTS application servers 120 provide the interfaces to communicate with COTS I/O servers 108, VMs 112a, and COTS master server 116.

In the outbound direction. COTS application servers 120 may select an optimal egress I/O interface (and corresponding COTS I/O server 108 or VM 112) based on an outbound mapping table, such as outbound mapping table 119 stored in COTS master sever 116 in FIG. 1B. In an embodiment, COTS application servers 120 may instead use any available I/O interface on COTS I/O server 108 or VMs 112.

Virtual fabric 107, shown in FIGS. 1A-B, is a logical overlay network that may be built on top of an existing IP network. In an embodiment, virtual fabric 107 may be an internal network and may not be accessible outside of distributed I/O system 100A. Virtual fabric 107 may provide for efficient communication among the COTS I/O servers 108, the COTS server 114, and the COTS application servers 120 through the use of virtual fabric ports. Each of COTS I/O servers 108, VMs 112, and COTS application server 120 may be connected to virtual fabric 107 through a single or multiple virtual fabric ports. In an embodiment, a virtual fabric port may be identified by a virtual fabric port ID assigned by COTS master server 116.

COTS master server 116 may be a processing entity (including COTS server, VMs, and blade servers) configured as a master node. COTS master server 116 may be responsible for the monitoring and the configuration of the COTS I/O servers 108. VMs 112, and COTS application servers 120. For example, as part of configuration, COTS master server 116 may determine and configure the number of VMs on COTS server 109. Additionally, COTS master server 116 may determine and update the number of buckets in LAG group 106 and the owner load balancing node(s) (COTS I/O servers 108 or VMs 112) of each bucket. By dynamically distributing the entire flow space for a particular type of key across the many processing entities of the LAG group 106, the distributed I/O architecture becomes massively scalable.

COTS master server 118 may also determine and/or select the particular algorithms each COTS I/O server 108 and/or VMs 112 is to use to extract particular flows for a particular packet type to be processed in a particular application. COTS master server 116 may download various control information such as the number of buckets and/or algorithms to the various processing entities. In an embodiment, there may be multiple COTS master servers needed to support a fast growing number of VMs in the LAG group 106. In such a case, the multiple COTS master servers may coordinate resource management amongst themselves.

In one embodiment, COTS master server 116 creates and maintains virtual interfaces 118 for the processing entities or nodes in the LAO group 106. A virtual interface 118a may contain the status, statistics, and other system information specific to for example COTS I/O server 108a and effectively, simulates the physical interface that is present in the remote COTS I/O server 108a for the kernel of COTS master server 116. Relatedly, COTS master server 116 may aggregate the statistics from multiple virtual interfaces 118 representing a single virtual network element. This information may be transmitted to COTS master server 116 through link control events (e.g. link/up down) and protocol traffic relating to the physical interfaces (e.g. 802.3ad LACP traffic). This control traffic may be sent from each COTS I/O server 108 to COTS master server 116 using a tunneling protocol that carries sufficient metadata along with the PDU (or event) to map it to the respective virtual interface 118 within COTS master server 116. For an example link aggregation mechanism such as ECMP, COTS master server 116 may construct additional required balancing tables with respect to virtual interfaces 118 to accurately simulate the physical interfaces, such as I/O interface 110, or logical interfaces, such as logical I/O interfaces 114. By creating representative virtual interfaces 118 in COTS master server 116 (or VM) for the I/O interfaces in the system, COTS master server 116 can manage the remote interfaces as though they were directly attached.

When new COTS I/O servers 108 or VMs 112 are to be installed and added to LAG group 106, COTS master server 116 may move one or more flow partitions (buckets) into the new COTS I/O servers 108 to improve redundancy and/or load balancing. Similarly, when VMs are removed from LAG group 106, due to administrative actions or failure, COTS master server 116 may reassign sectors or a portion of the flow keys of the flow partition of the removed VMs into at least one of the active VMs 112 and/or COTS I/O servers 108. In an embodiment, any redistribution of flow partitions or parts of flow partitions may involve propagating the information regarding redistribution to all the load balancing nodes, such as COTS I/O servers 108a-h and VMs 112, in the LAG group and the system.

COTS standby master server 120 may be a processing entity such as one or more COTS servers, one or more VMs, or one or more blade servers, designated as a backup master server. COTS standby master server 120 may take over the operations and the functionalities of COTS master server 116 if COTS master server 116 fails. The additional independent designated processing entity COTS standby master server 120 provides extra redundancy to distributed I/O systems 100A and 100B.

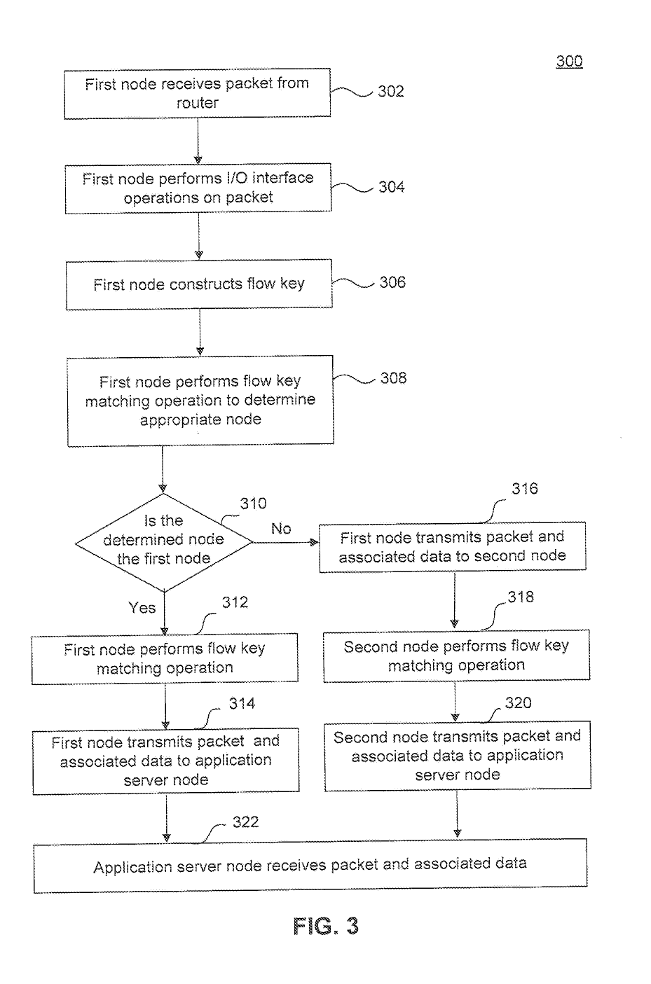

FIG. 3 is a flowchart illustrating process 300 for load balancing in distributed I/O architecture system 100, according to an example embodiment. Reference to components and processes are made in continuous reference to FIGS. 1-2. Process 300 can be performed by processing logic that can comprise hardware (e.g., circuitry, dedicated logic, programmable logic, microcode, etc.), software (e.g., instructions run on a processing device), or a combination thereof.

In step 302, a first load balancing node, such as COTS I/O server 108a, may receive a packet from a router 104, as explained in the descriptions of COTS I/O servers 108 and router 104 in FIG. 1A.

In step 304, the first load balancing node may perform I/O interface operations on the received packet, as described in FIG. 2.

In step 306, the first load balancing node may extract and/or alternatively construct a flow key using the packet and metadata associated with the packet, as described in FIG. 2.

In step 308, the first load balancing node may perform a flow key matching operation through the use of a bucket-to-node lookup table 206 to locate an appropriate load balancing node capable of processing the packet, as described in FIG. 2. In an embodiment, the constructed flow key may contain the bucket information so that when the flow key and received packet is forwarded to a second load balancing node for processing, the bucket value does not need to be looked up in a separate bucket-to-node lookup table 206 at the second load balancing in order to index into one of bucket tables 210 of node-to-flow lookup tables 208 at the second load balancing node.

In step 310, the first load balancing node determines whether the located appropriate load balancing node is in fact the first load balancing node, as explained in FIG. 2.

In step 312, if the appropriate node was the first load balancing node, then the first load balancing node may perform an exact flow key matching operation using one of bucket tables 210 of node-to-flow lookup tables 210, described in FIG. 2A.

In step 314, the first load balancing node may transmit at least one of the packet, flow key, and associated metadata to one of COTS application servers 120 identified from the result of step 312, as described in FIG. 2. In an embodiment, the results from the matching operation in step 312 identifies a specific process on one of COTS application servers 120 to receive the packet.

In step 316, the appropriate node was determined to be a second load balancing node, so the first load balancing node may transmit at least one of the packet, flow key, and associated metadata to the second load balancing node, as described in FIG. 2A.

In step 318, analogous to step 312, the second load balancing node may perform an exact flow key matching operation using an identified bucket table 210 of node-to-flow lookup tables 210, described in FIG. 2A.

In step 320, analogous to step 314, the second load balancing node may transmit at least one of the packet, flow key, and associated metadata to one of COTS application servers 120 identified from the result of step 318, as described in FIG. 2A.

Finally in step 322, the identified COTS application server 122 may receive at least one of the packet, the flow key, and the metadata associated with the packet.

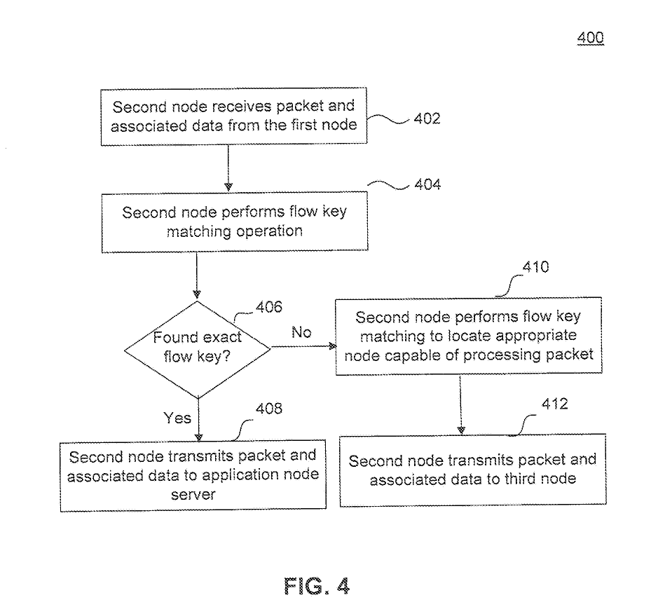

FIG. 4 is a flowchart illustrating process 400 for performing load balancing in a distributed I/O architecture system that may allow flows to be remapped during packet processing, following the step of 316 from FIG. 3, according to an example embodiment. Reference to components and procedures are made to FIGS. 1-3. Process 400 can be performed by processing logic that can comprise hardware (e.g., circuitry, dedicated logic, programmable logic, microcode, etc.), software (e.g., instructions run on a processing device), or a combination thereof.

In step 402, a second load balancing node, such as VM 112a of COTS server 109, may receive at least one of the packet, flow key, and metadata associated with the packet from a first load balancing node.

In step 404, analogous to step 318, the second load balancing node may perform an exact flow key matching operation using one of bucket tables 210 of node-to-flow lookup tables 208 determined based on the received information of step 402, described in FIG. 2A.

In step 406, the second load balancing node attempts to find an exact matching flow key in its node-to-flow lookup tables 208. A match may not be found if, for example, distributed I/O system 100A relocated the particular flow while packets are mid-flight in order to redistribute flow loads, as explained in FIG. 2.

In step 408, if the exact flow key was matched and found, the second load balancing node may transmit at least one of the packet, flow key, and associated metadata to a COTS application server, such as COTS application server 120a, identified from the result of step 404, as described in FIG. 2A.

In step 410, if the second load balancing node did not find a match in its node-to-flow lookup tables 208, the second load balancing node may perform a flow key matching operation through the use of its bucket-to-node lookup table 206 to locate an appropriate load balancing node capable of processing the packet, as described in FIG. 2.

In step 412, the appropriate node was determined to be a third node, so the second load balancing node may transmit at least one of the packet, flow key, and associated metadata to the third load balancing node, as described in FIG. 2A.

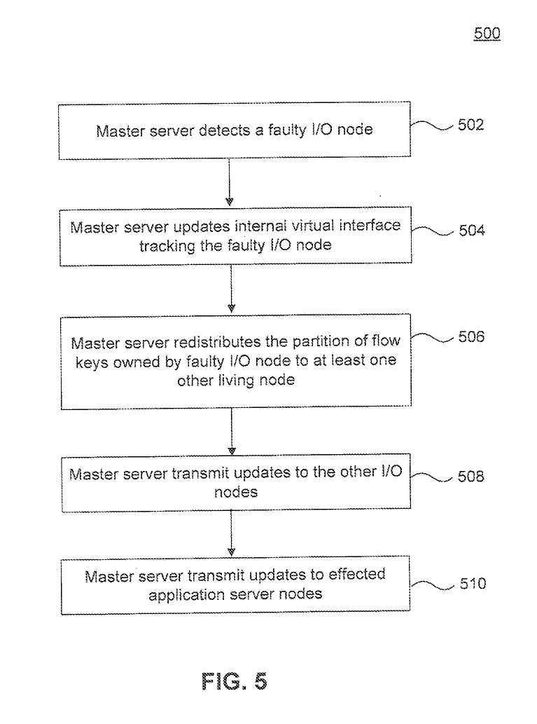

FIG. 5 is a flowchart illustrating process 500 that COTS master server 116 may perform to respond to changes in the I/O system state, according to an embodiment. Process 500 can be performed by processing logic that can comprise hardware (e.g., circuitry, dedicated logic, programmable logic, microcode, etc.), software (e.g., instructions run on a processing device), or a combination thereof.

In step 502, a COTS master server, such as COTS master server 116, may detect a node, such as load balancing COTS I/O server 108a, is non-functional, non-responsive, or in a faulty state based on the state of its virtual interface, such as virtual interfaces 118a corresponding to COTS I/O server 108a. COTS master server 116 may detect these faults through a continuous monitoring of the statuses of COTS I/O servers 108 or VMs 112. This monitoring may be possible through the use of selective polling. In an embodiment, COTS master server 116 may detect a new COTS I/O server has been installed or incorporated into LAG group 106.

In step 504, the COTS master server may update internal virtual interfaces 118, such as virtual interfaces 118a, in response to the detection in 502. In an embodiment, COTS master server 116 may remove virtual interface 118a tracking the faulty COTS I/O server 108a. Alternatively, when a new I/O server is detected, COTS master server 116 may instead instantiate and configure virtual interface 118a as a new virtual interface corresponding to the new I/O server.

In step 506, the COTS master server may redistribute at least a portion of the partition of the possible flow keys owned by the faulty node, COTS I/O server 108a, to at least one living load balancing node. The at least one living load balancing node may be a dedicated load balancing node, implemented on one or more COTS I/O servers 108, without I/O interfaces 110. In an embodiment, the at least one living load balancing node may be part of an inverse multiplexed group, such as LAG group 106. Alternatively, with a newly detected node, COTS master server 116 may instead redistribute at least a portion of the partition of the possible flow keys from one or more other living and functioning load balancing nodes of the LAG group 106 to the new I/O server.

In step 508, the COTS master server may propagate and push updates to the various lookup tables described in FIGS. 1-2 such as bucket-to-node lookup tables 206 and node-to-flow lookup tables 208 in COTS I/O servers and VMs in the system. In an embodiment, these I/O servers and VMs may be part of LAG group 106.

In step 510, the COTS master server may transmit updates to effected COTS application servers 120 and update the respective virtual interfaces 122.

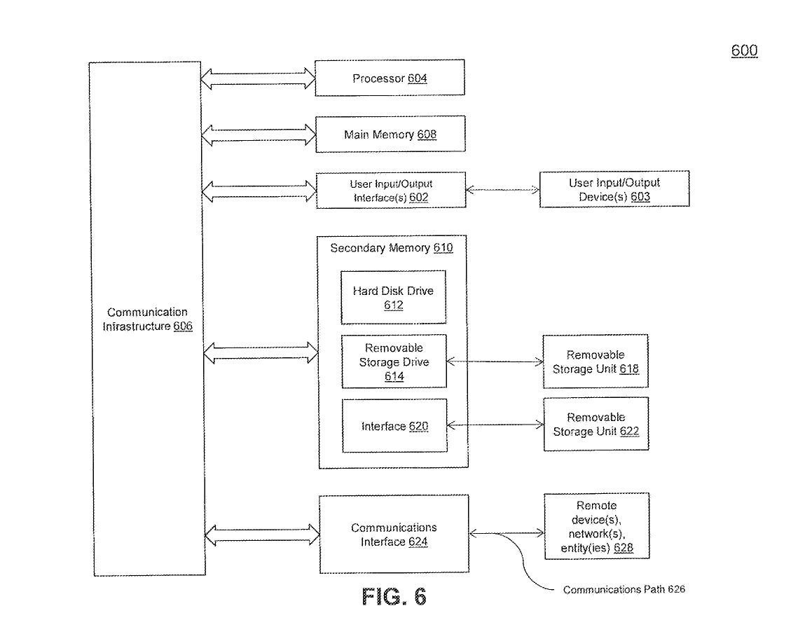

Various embodiments can be implemented, for example, using one or more well-known computer systems, such as computer system 600 shown in FIG. 6. For example, COTS I/O server 108, COTS server 114, router 104, COTS standby master server 120, COTS master server 116, and COTS application servers 120 may be implemented as computer system 600. Computer system 600 can be any well-known computer capable of performing the functions described herein.

Computer system 600 includes one or more processors (also called central processing units, or CPUs), such as a processor 604. Processor 604 is connected to a communication infrastructure or bus 606.

One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 6. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended, to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A system, comprising:
a first load balancer, implemented by one or more servers, comprising an input/output (I/O) interface for receiving a packet from a network, wherein the first load balancer is a member of an inverse multiplexed group of load balancers sharing a common Internet Protocol (IP) address, and wherein the first load balancer is configured to:
construct a flow key using portions of the packet, the portions selected based on a protocol type of the packet,
generate a bucket value by hashing the flow key, the bucket value identifying a bucket of flow keys,
locate a second load balancer for processing the packet by looking up the bucket value from a bucket-to-node lookup table stored on the first load balancer, wherein the second load balancer contains the bucket, and
forward at least one of the packet, the flow key, or metadata associated with the packet to the second load balancer, wherein the second load balancer is configured to:
perform a flow key lookup using a node-to-flow lookup table stored on the second load balancing node to determine an application server for processing the packet, and
transmit at least one of the packet, the flow key, and associated metadata to the application server.

2. The system of claim 1, wherein the second load balancer is another member of the inverse multiplexed group, and wherein the inverse multiplexed group is maintained through one of a Link Aggregation Group (LAG) group, equal cost multi-path (ECMP), or Link Bonding.

3. The system of claim 1, wherein the first load balancer, the second load balancer, and the application server are each implemented on a commercial off-the-shelf (COTS) server, a blade server, or a virtual machine (VM).

4. The system of claim 1, wherein the first load balancer is further configured to:
filter, by a packet analyzer unit on the first load balancer, the packet arriving at the I/O interface based on an attribute of the packet, the attribute including a portion of the packet, the flow key of the packet, or a bucket value of the packet; and
send the filtered packet and attribute to the application server or a master server including a virtual interface corresponding to the I/O interface.

5. The system of claim 1, wherein the metadata specifies the flow key and identifies within the application server a process capable of executing the packet.

6. The system of claim 1, wherein the first load balancer is further configured to:
send an interface status of the I/O interface to a master server including a virtual interface corresponding to the I/O interface, wherein the master server communicates the interface status to the application server.

7. The system of claim 6, wherein the first load balancer is further configured to:
receive configuration updates from the master server, wherein the configuration updates are generated by the master server responsive to receiving the interface status; and
remove, in accordance with the configuration updates, one or more buckets within the first load balancer if the first load balancing node is faulty or if the flow keys are to be redistributed to a new load balancing node detected by the master server.

8. The system of claim 7, wherein the first load balancer is further configured to:
add, in accordance with the configuration updates, a second bucket of flow keys from a third load balancing node to the first load balancer if the first load balancing node is a new node detected by the master server or if the third load balancing node is detected by the master server to be faulty.

9. The system of claim 1, wherein the packet is a fragment of a fragmented packet, and wherein the first load balancer is further configured to:
receive subsequent packets corresponding to fragments of the fragmented packet; and
forward the subsequent packets to the second load balancer, wherein the second load balancer is further configured to reassemble the fragmented packet using the packet and subsequent packets, and perform flow key lookup based on the reassembled fragmented packet.

10. A method for supporting Network Functions Virtualization (NFV), comprising:
receiving a packet, by an input/output (I/O) interface on a first load balancer implemented by one or more servers, wherein the first load balancer is a member of an inverse multiplexed group of load balancers sharing a common Internet Protocol (IP) address;
constructing, by the first load balancer, a flow key using portions of the packet, the portions selected based on a protocol type of the packet;
generating, by the first load balancer, a bucket value by hashing the flow key, the bucket value identifying a bucket of flow keys;
locating, by the first load balancer, a second load balancer for processing the packet by looking up the bucket value from a bucket-to-node lookup table stored on the first load balancer, wherein the second load balancer contains the bucket; and
forwarding, by the first load balancer, at least one of the packet, the flow key, or metadata associated with the packet to the second load balancer, wherein the forwarding causes the second load balancer to:
perform a flow key lookup using a node-to-flow lookup table stored on the second load balancer to determine an application server for processing the packet; and
transmit at least one of the packet, the flow key, and the metadata to the application server.

11. The method of claim 10, wherein the second load balancer is another member of the inverse multiplexed group, and wherein the inverse multiplexed group is maintained through one of a Link Aggregation Group (LAG) group, equal cost multi-path (ECMP), or Link Bonding.

12. The method of claim 10, wherein the first load balancer, the second load balancer, and the application server are each implemented on a commercial off-the-shelf (COTS) server, a blade server, or a virtual machine (VM).

13. The method of claim 10, further comprising:
filtering, by a packet analyzer unit on the first load balancer, the packet arriving at the I/O interface based on an attribute of the packet, the attribute including a portion of the packet, the flow key of the packet, or a bucket value of the packet; and
sending, by the first load balancer, the filtered packet and attribute to the application server or a master server including a virtual interface corresponding to the I/O interface.

14. The method of claim 10, wherein the metadata specifies the flow key and identifies within the application server a process capable of executing the packet.

15. The method of claim 10, further comprising:
sending, by the first load balancer, an interface status of the I/O interface to a master server including a virtual interface corresponding to the I/O interface, wherein the master server communicates the interface status to the application server.

16. The method of claim 15, further comprising:
receiving, by the first load balancer, configuration updates from the master server, wherein the configuration updates are generated by the master server responsive to receiving the interface status; and
removing, by the first load balancer, in accordance with the configuration updates; one or More buckets within the first load balancer if the first load balancing node is faulty or if the flow keys are to be redistributed to a new load balancing node detected by the master server.

17. The method of claim 16, further comprising:
adding, by the first load balancer, in accordance with the configuration updates, a second bucket of flow keys from a third load balancing node to the first load balancer if the first load balancing node is a new node detected by the master server or if the third load balancing node is detected by the master server to be faulty.

18. The method of claim 10, wherein the packet is a fragment of a fragmented packet, the method further comprising:
receiving, by the first load balancer, subsequent packets corresponding to fragments of the fragmented packet; and
forwarding, by the first load balancer, the subsequent packets to the second load balancer, wherein the second load balancer is further configured to reassemble the fragmented packet using the packet and subsequent packets, and perform flow key lookup based on the reassembled fragmented packet.

19. A program storage device tangibly embodying a program of instructions executable by at least one machine to perform a method supporting Network Functions Virtualization (NSFV), comprising;
receiving a packet, by an input/output (I/O) interface on a first load balancer implemented by one or more servers, wherein the first load balancer is a member of an inverse multiplexed group of load balancers sharing a common Internet Protocol (IP) address;
constructing, by the first load balancer, a flow key using portions of the packet, the portions selected based on a protocol type of the packet;
generating, by the first load balancer, a bucket value by hashing the flow key, the bucket value identifying a bucket of flow keys;
locating, by the first load balancer, a second load balancer for processing the packet by looking up the bucket value from a bucket-to-node lookup table stored on the first load balancer, wherein the second load balancer contains the bucket; and
forwarding, by the first load balancer, at least one of the packet, the flow key, or metadata associated with the packet to the second load balancer, wherein the forwarding causes the second load balancer to:
perform a flow key lookup using a node-to-flow lookup table stored on the second load balancer to determine an application server for processing the packet; and
transmit at least one of the packet, the flow key, and the metadata to the application server.

20. The program storage device of claim 19, the method further comprising:
filtering, by a packet analyzer unit on the first load balancer, the packet arriving at the I/O interface based on an attribute of the packet, the attribute including a portion of the packet, the flow key of the packet, or a bucket value of the packet; and
sending, by the first load balancer, the filtered packet and attribute to the application server or a master server including a virtual interface corresponding to the I/O interface.
